(19) United States
(12) Patent Application Publication
(10) Pub. No.: US 2019/0191463 A1
(43) Pub. Date: Jun. 20, 2019

(54) GUARD TERMINAL APPARATUS, ACCESS POINT, RADIO COMMUNICATION APPARATUS, AND TRANSMISSION METHOD

(71) Applicant: SHARP KABUSHIKI KAISHA, Sakai City, Osaka (JP)

(72) Inventors: HIDEO NAMBA, Sakai City (JP); HIROMICHI TOMEBA, Sakai City (JP); YASUHIRO HAMAGUCHI, Sakai City (JP); SHINICHI MIYAMOTO, Wakayama-shi, Wakayama (JP)

(21) Appl. No.: 16/326,179

(22) PCT Filed: Aug. 29, 2017
(86) PCT No.: PCT/JP2017/030869

§ 371 Date: Feb. 15, 2019

(30) Foreign Application Priority Data
Sep. 5, 2016 (JP) 2016-172694

(51) Int. Cl. H04W 74/08; H04W 24/02; H01Q 13/20

(52) U.S. Cl. CPC H04W 74/0816; H01Q 13/203; H04W 24/02

(57) ABSTRACT

In a case that interference is received from the surrounding wireless communication apparatuses, the interference signals are reduced thereby improving a communication efficiency. A guard terminal apparatus is used with an access point wirelessly communicating with a wireless terminal apparatus, outputs a signal to perform medium reservation, and includes a leaky coaxial cable configured to wirelessly transmit a signal for performing the medium reservation. The leaky coaxial cable is arranged in a part of a coverage of the access point. The access point or another guard terminal apparatus used with the access point transmits a signal to shorten a reserved period which is based on a transmitted medium reservation signal.

### TECHNICAL FIELD

This invention relates to radio communication technology, particularly to, a guard terminal apparatus, an access point, a radio communication apparatus, and transmission method.

### BACKGROUND ART

Wireless LAN (Local Area Network) based on IEEE802.11 has become widespread as a wireless network using an unlicensed band that is a frequency band for which no license is necessary. A wireless LAN system shares the unlicensed band with other wireless LAN systems and the like by using CSMA/CA (Carrier Sense Multiple Access/Collision Avoidance) scheme.

The wireless LAN is established at home or the like to be used as a private network. The wireless LAN is also established in commercial facilities such as shops, shopping malls, and stadiums, which is open to customers and used by the commercial facilities for their business operations.

In addition, a mobile type wireless LAN access point (base station) capable of accessing the Internet via a mobile radio communication network, and a mobile phone terminal such as a smartphone that has a tethering function and functions as a wireless LAN access point are also widely used.

Since a wireless network using an unlicensed band is likely to be freely used by many people, and interference may be received from other persons even in a case that the wireless network is used in a specific space such as a commercial facility, various methods of medium reservation for reducing such interference is being studied (for example, NPL 1).

With respect to the medium reservation, a similar method is proposed for securing a medium for transmitting network management information under the CSMA/CA environment (for example, Patent Literature 1).

### CITATION LIST

### Patent Literature

Patent Document 1: JP 2016-019238 A

### Non Patent Literature

NPL 1: “A Proposal of Efficient Medium Reservation Scheme for Intra-BSS Centralized WLAN Systems”, Junya Muneta, Shinichi Miyamoto, Seiichi Sampei, Wenjie Jiang (IEICE Tech. Rep., RSC2014-263, December 2014)

### SUMMARY OF INVENTION

### Technical Problem

However, in a case of providing a guard range by the guard terminal using the technique described in NPL 1 in a space having a certain degree of size, as illustrated in FIG. 16, many guard terminals 1002a to 1002f (six in the example of FIG. 16) need to be arranged to configure the guard range (the range expressed by the broken line).

Configuring a wide guard range while limiting the number of guard terminals causes a guard range that each guard terminal is in charge of to be configured wider. This causes the signal transmitted by the guard terminals 1002a to 1002f to reach beyond the service area of the access point 1001, which is not preferable from the viewpoint of effective utilization of radio waves. In order to minimize the signal that reaches beyond the service area of the access point 1001, a technique has been indicated that allows the monitoring terminals 1003a to 1003f (six in the example of FIG. 16) to be arranged outside the guard terminals 1002a to 1002f to monitor the signal transmitted by the guard terminals 1002a to 1002f, and feedback to the monitoring terminals the strength of the signal of the guard terminal received by the monitoring terminals to optimize the transmission power of the guard terminals 1002a to 1002f. In this case, however, the number of monitoring terminals required is almost the same as the number of the guard terminals. There is a problem in that unless a sufficient number of monitoring terminals are provided, the transmission power of the guard terminals 1002a to 1002f may not be appropriately configured.

In addition, in a case that the desired guard range is of an approximately-circular shape as illustrated in FIG. 16, it is possible to configure a guard range to have nearly uniform characteristics by arranging the guard terminals at a similar interval. However, in a case that the desired guard range is of a rectangular or deformed polygon shape, or a specific adjacent range is not to be guarded, there is a problem in which arranging the guard terminals becomes difficult, and in some cases the desired guard range cannot be configured.

In addition, in the technique described in NPL 1, the access point 1001 periodically transmits a CTS packet in order to perform medium reservation for other terminals that do not belong to the network as illustrated in FIG. 17. In order to perform the medium reservation for other terminals at a distance from the service area of the access point 1001, the CTS packets for configuring the NAV are also transmitted from the guard terminals 1002a to 1002f in a sequence. In this case, there is a problem in that a period available for communication is reduced by the period required to transmit a large number of CTS packets.

The present invention has been made in view of such circumstances, and its object is to provide a guard terminal apparatus, an access point, a radio communication apparatus, and a transmission method that can improve communication efficiency in a case that there is interference from surrounding radio communication apparatuses.

### Solution to Problem

In order to accomplish the object described above, the present invention is contrived to provide the following means. Namely, a guard terminal apparatus according to one aspect of the present invention is a guard terminal apparatus to be used with an access point that wirelessly communicates with a wireless terminal apparatus, the guard terminal apparatus including, a controller configured to output a signal for performing a medium reservation, and a leaky coaxial cable configured to wirelessly transmit the signal for performing the medium reservation.

### Advantageous Effects of Invention

According to one aspect of the present invention, a transmission of a signal for medium reservation from a leaky coaxial cable provided in a guard terminal reduces transmission opportunities for a wireless terminal apparatus that is not connected to an access point, thus enabling communication efficiency to be improved. Also, shortening the period reserved by the signal for medium reservation enables the communication efficiency to be improved. Further, transmitting the signal for medium reservation in a frequency channel adjacent to a frequency channel used by the access point enables interference signals to be reduced, thus allowing the communication efficiency to be improved.

### BRIEF DESCRIPTION OF DRAWINGS

FIG. 1 is a diagram illustrating an example of a system configuration according to an embodiment of the present invention.

FIG. 2 is a diagram illustrating an example of a configuration of an apparatus to be used according to an embodiment of the present invention.

FIG. 3 is a diagram illustrating an example of a range of medium reservation according to an embodiment of the present invention.

FIG. 4 is a diagram illustrating an example of a range of monitoring according to an embodiment of the present invention.

FIG. 5 is a diagram illustrating an example of a flow of processing a power control according to an embodiment of the present invention.

FIG. 6 is a diagram illustrating an example of a flow of processing an access point according to an embodiment of the present invention.

FIG. 7 is a diagram illustrating an example of a flow of guard processing of a guard terminal according to an embodiment of the present invention.

FIG. 8 is a diagram illustrating an example of a flow of processing a power control according to an embodiment of the present invention.

FIG. 9 is a timing chart illustrating an example of a power control according to an embodiment of the present invention.

FIG. 10 is a diagram illustrating an example of a system configuration according to an embodiment of the present invention.

FIG. 11 is a timing chart illustrating an example of processing according to an embodiment of the present invention.

FIG. 12A is a timing chart illustrating an example of processing according to an embodiment of the present invention.

FIG. 12B is a timing chart illustrating an example of processing according to an embodiment of the present invention.

FIG. 13 is a timing chart illustrating an example of processing according to an embodiment of the present invention.

FIG. 14A is a diagram illustrating an example of a frequency channel allocation and an example of a processing flow according to an embodiment of the present invention.

FIG. 14B is a diagram illustrating an example of a frequency channel allocation and an example of a processing flow according to an embodiment of the present invention.

FIG. 15A is a diagram illustrating an example of a frequency channel allocation according to an embodiment of the present invention.

FIG. 15B is a diagram illustrating an example of a frequency channel allocation according to an embodiment of the present invention.

FIG. 16 is a diagram illustrating a system according to an embodiment of the technique described in NPL 1.

FIG. 17 is a diagram illustrating an example of a processing flow of an embodiment of the technique described in NPL 1.

### DESCRIPTION OF EMBODIMENTS

Hereinafter, a radio communication technique according to an embodiment of the present invention will be described in detail with reference to the drawings.

### First Embodiment

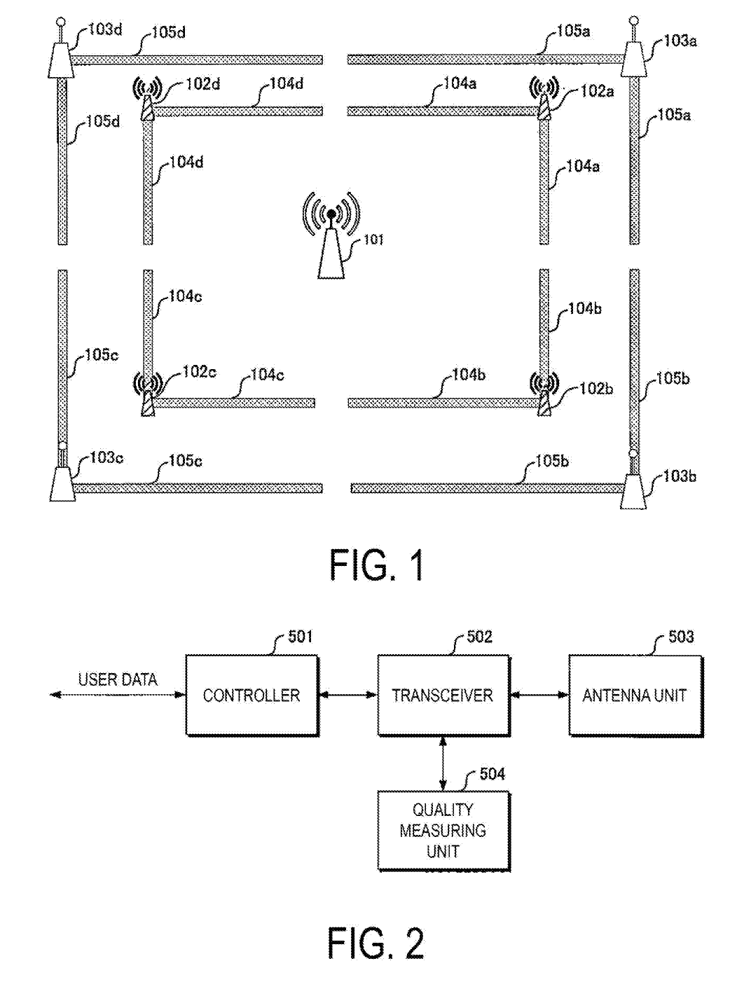

An outline of an example of a wireless communication system to which the present embodiment is applied is illustrated in FIG. 1. This wireless system is constituted by a single access point 101, four guard terminals 102a to 102d, four monitoring terminals 103a to 103d, a leaky coaxial cable (LCX) 104a to 104d connected to each of the four guard terminals 102a to 102d, and a leaky coaxial cable 105a to 105d connected to each of the four monitoring terminals 103a to 103d, respectively. The access point 101, the guard terminals 102a to 102d, and the monitoring terminals 103a to 103d can have a radio communication with each other.

FIG. 2 illustrates a functional block diagram of an example configuration of the access point 101, the guard terminals 102a to 102d, and the monitoring terminals 103a to 103d. Reference sign 501 denotes a controller configured to manage user data for communication and control other blocks to perform a flow described below, reference sign 502 is a transceiver configured to modulate and demodulate communication data, convert transmission data to an RF signal, or demodulate the RF signal to receive data, reference sign 503 is an antenna unit configured to transmit the RF signal output from the transceiver 502, or receive the RF signal transmitted from other apparatuses and input the RF signal received to the transceiver, and reference sign 504 is a quality measuring unit configured to measure the quality of a received signal by using a part of the signal processed by the transceiver unit 502.

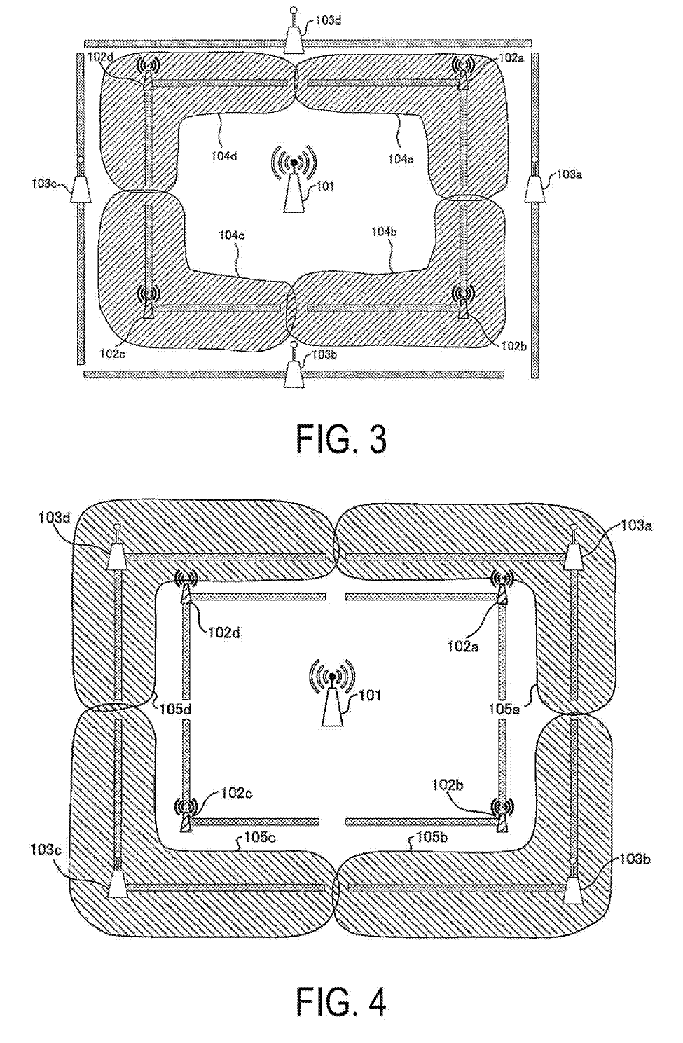

An example of a range will be described with reference to FIG. 3. In the range, a signal transmitted from the LCX connected to the guard terminals 102a to 102d can be received at an intensity that allows the signal to be demodulated. A range in which a signal transmitted from the LCX connected to the guard terminal 102a can be received is indicated by 104a, a range in which a signal transmitted from the LCX connected to the guard terminal 102b can be received is indicated by 104b, a range in which a signal transmitted from the LCX connected to the guard terminal 102c can be received is indicated by 104c, and a range in which a signal transmitted from the LCX connected to the guard terminal 102d can be received is indicated by 104d. Changing the transmission output of each of the guard terminals 104a to 104d changes the size of each of the ranges 104a to 104d. Further, the shapes of the ranges 104a to 104d can be changed by the arrangement of the LCX connected to the guard terminals 102a to 102d. Further, the ranges 104a to 104d can be changed by changing the characteristics (leakage characteristics) of the LCX. It is also possible to partially change the characteristics of the LCX to change the range.

A range in which the monitoring terminals 103a to 103d can detect a terminal that performs a transmission of a prescribed transmission output will be described with reference to FIG. 4. The range in which the monitoring terminal 103a can detect the terminal that performs a transmission of the prescribed transmission output is indicated by 105a, the range in which the monitoring terminal 103b can detect the terminal that performs a transmission of the prescribed transmission output is indicated by 105b, the range in which the monitoring terminal 103c can detect the terminal that performs a transmission of the prescribed transmission output is indicated by 105c, and the range in which the monitoring terminal 103d can detect the terminal that performs a transmission of the prescribed transmission output is indicated by 105d. These ranges 105a to 105d can be changed according to the arrangement of the LCX connected to the monitoring terminals 103a to 103d. Moreover, these ranges can be changed by changing the characteristics of the LCX.

The access point 101, the guard terminals 102a to 102d, and the monitoring terminals 103a to 103d use a Distributed Coordination Function (DCF) protocol of wireless LAN IEEE 802.11 in a communication. The DCF protocol is one of the Carrier Sense Multiple Access/Collision Avoidance (CSMA/CA) scheme. In the CSMA/CA, a carrier sense is performed prior to a transmission, and then a random backoff is used to avoid a collision. An exchange of a Request To Send (RTS), also referred to as a transmission request)/a Clear To Send (CTS), also referred to as a transmission permission) may be further involved to solve a hidden terminal problem, and the DCF of the IEEE 802.11 includes the exchange of a RTS/a CTS.

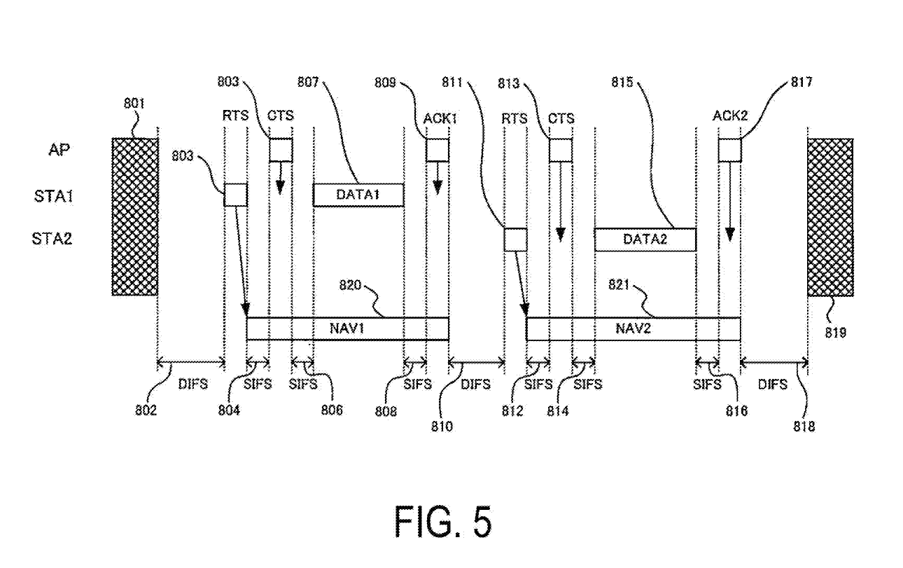

An example of communication by the DCF protocol will be described with reference to FIG. 5. FIG. 5 illustrates, by using a timing chart, an example in which an AP (also referred to as an access point, or a radio control apparatus) communicates with two STAtions (STAs, also referred to as a wireless terminal apparatus, or a terminal apparatus), and a STA1 communicates with the AP, and immediately thereafter a STA2 communicates with the AP. First, the STA1 waits until the transmission 801 of the AP or any of the STAs ends. After the completion of the transmission, the STA1 waits during Distributed coordination function InterFrameSpace (DIFS) period 802, and transmits RTS 803 to the AP. The DIFS is a delay period for the DCF (Distributed Coordination Function), in which a default period is configured to be longer than the SIFS described later, and a random backoff period is further added.

A Network Allocation Vector (NAV) (NAV1 820) is set, at the time when the RTS 803 is transmitted, to prevent another STA from performing a transmission during a subsequent prescribed period. The NAV is also referred to as a transmission prohibition period or a medium reservation period. In the NAV, a period required for a transmission of a CTS, a transmission of data, and a transmission of an ACKnowledge (ACK, also referred to as acknowledgment) in response to the transmission of the data. The other STA that has received the NAV are prohibited from performing a transmission during the period being set. In a case of normally receiving the RTS 803, the AP assumes that no STA is using the radio resources, waits during a Short InterFrame Space (SIFS) period 804, and transmits a CTS 805 to the STA1.

A SIFS is the minimum specified period for the AP or the STA to perform a next transmission, and is the period specified to prevent an interruption by another STA or the like at the time when essential packets such as ACK, RTS, CTS are transmitted. A period, specified for DIFS and the like, for starting the DCF access is longer than the period of the SIFS, thus allowing the transmission of essential packets to be prioritized. The AP also sets the NAV at the time of transmitting the CTS 805. The NAV set by the AP is set to a value obtained by subtracting the period required for transmission and reception of the RTS 803 from the period set for the RTS 803, namely, substantially the same value as the value set for the RTS 803. This enables STAs that could not receive the RTS to obtain substantially the same NAV.

Subsequently, the STA1 that has received the CTS 805 transmits DATA1 807 to the AP after waiting during a SIFS period 806 with the assumption that the transmission right is obtained. The AP that has received the DATA1 807 waits during a SIFS period 808, and transmits an ACK1 809 to the STA1. The STA1 that has received the ACK determines that the transmission of the DATA1 807 is completed and performs no further transmission. The STA2 receives the communication between the STA1 and the AP while waiting during the period of the NAV1 820, and transmits a RTS 811 to the AP after waiting a DIFS period 810 from the timing at which all the transmissions have been completed. At the time of transmission of the RTS 811, the period required for transmission of a CTS, transmission of data, and transmission of an ACK in response to the transmission of the data is set as a NAV2 821. In case of normally receiving the RTS 811, the AP assumes that no STA is using a radio resource, waits during a SIFS period 812, and transmits a CTS 813 to the STA2. At the period of transmission of the CTS 813, the period required for receiving the RTS is subtracted in the same manner as described above, and a period that is substantially the same as the NAV2 is set as the NAV. In case of receiving the CTS 813, the STA2 assumes that the transmission right is obtained and transmits DATA2 815 to the AP after waiting during a SIFS period 814.

The AP that has normally received the DATA2 815 waits during a SIFS period 816, and transmits an ACK2 817 to the STA2. The STA2 that has received the ACK2 817 determines that the transmission is completed and performs no further transmission. Thereafter, after a DIFS period 818 elapses, another DCF access 819 can be performed. The DCF protocol prevents, with the procedure described above, a collision of packet, thus enabling data transmissions among a plurality of STAs.

In the present embodiment, in a case that the access point 101, the guard terminals 102a to 102d, the monitoring terminals 103a to 103d, and the other STAs connected to the access point 101 communicate with each other, the DCF protocol is used such that the NAV transmitted from the guard terminals 102a to 102d or transmitted to the guard terminals 102a to 102d is ignored. Namely, during the period of the NAV in which the addresses of the guard terminals 102a to 102d are included, other terminals that are not connected to the access point 101 determine that a medium is occupied, and the terminals that are connected to the access point 101 determine that the medium is available, thus causing the medium to be reserved by the guard terminals 102a to 102d.

The method that notifies the terminal connected to the access point 101 of the address in the NAV which may be ignored is not particularly limited. As an example, a vendor specific field may be provided in the beacon to be periodically transmitted by the access point 101, and the addresses of guard terminals 102a to 102d currently operating may be listed in the vendor specific field. In addition, the access point 101 may notify, to the terminal connected at the time of association operation, the addresses of the guard terminals 102a to 102d connected to the access point 101 by using the vendor specific field. A terminal apparatus that is connected to the access point 101 and has been notified of the addresses of the guard terminals 102a to 102d may ignore the NAV transmitted by the guard terminals 102a to 102d.

In a case that a NAV that was transmitted from an unknown transmission apparatus has been remaining, and that another NAV including an address of the guard terminal is received, it may be assumed that the NAV is reset. This allows the terminal apparatus to behave as if the medium is reserved by the guard terminals 102a to 102d. In another example, the access point 101 may notify the NAV that may be ignored through a BSS identification information (BSS color) which is information for identifying the BSS. The BSS identification information may be explicitly described in a PHY header/MAC header or the like, or may be implicitly notified to the terminal according to differences among the modulation schemes/transmission methods. This allows the terminal apparatus to behave as if the medium is reserved by the guard terminals 102a to 102d.

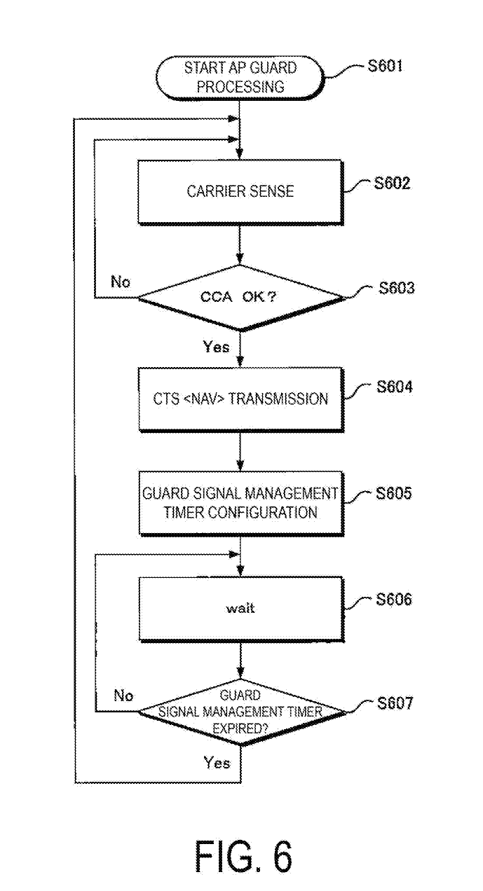

The access point 101 periodically transmits the NAV to the guard terminals 102a to 102d. A flow of the processing will be described with reference to FIG. 6. The start of the processing is S601. After the start, carrier sense is performed in S602, and Clear Channel Assessment (CCA) determination is made in S603 based on a result of the carrier sense. In a case that it is determined that the channel is clear, the process proceeds to S604, and in a case that it cannot be determined that the channel is clear, the process returns to S602. In S604, the access point 101 transmits a CTS packet in which a NAV for medium reservation is set, to the guard terminal 102a. In order to indicate that the CTS packet has been transmitted to the guard terminal 102a, the address of the guard terminal 102a is set in the RA field of the CTS packet to be transmitted. Next, in S605, the access point 101 sets the timer for guard signal management to a prescribed value and starts the timer.

In a case that the period until the timer expires is equal to or less than the period of the NAV set in S604, the number of opportunities of transmission can be significantly reduced for a terminal apparatus which is not connected to the access point 101. In a case that the period until the timer expires is made longer than the period of the NAV set in S604, an opportunity of transmission is given to a terminal apparatus which is not connected to the access point 101. After configuring the timer, the process proceeds to S606. The access point 101 waits for a prescribed period, and then the process proceeds to S607. In S607, whether the timer for managing the guard signal has expired is determined. In a case that the timer has not expired, the process returns to S606. In a case that the timer has expired, the process returns to S602. The access point 101 controls the guard terminal by repeating the above process.

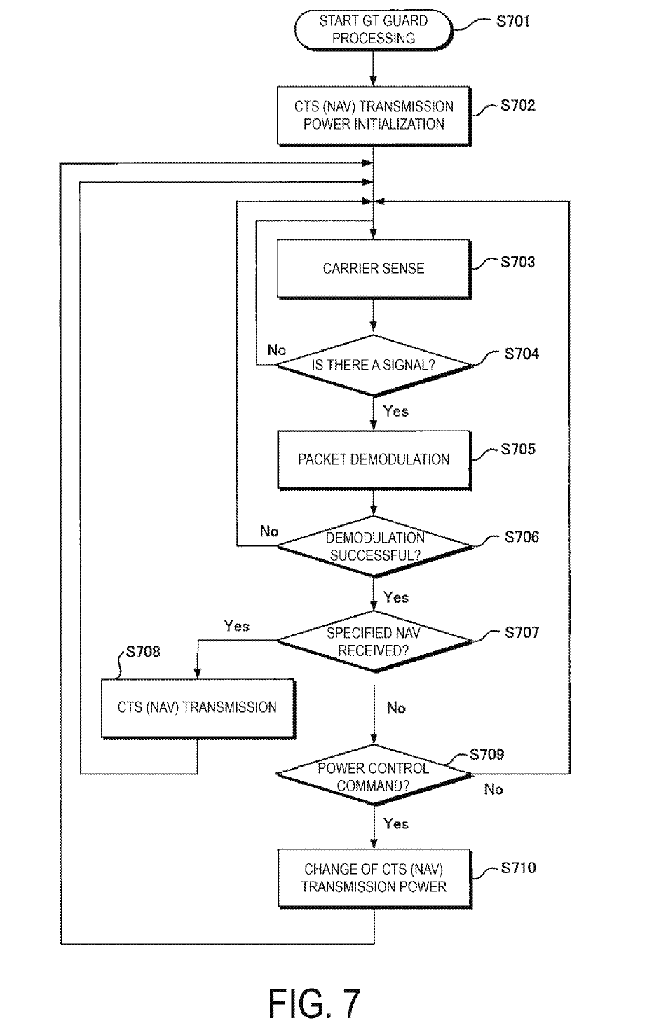

Next, a flow of the processing of the guard terminals 102a to 102d will be described with reference to FIG. 7. Prior to starting the flow, the guard terminals 102a to 102d communicate with the access point 101 to predetermine an order for transmitting the NAVs. In the present embodiment, transmissions are performed in the order of the guard terminal 102a, the guard terminal 102b, the guard terminal 102c, and the guard terminal 102d. In order to transmit the NAVs in the order, in a case that the guard terminal 102a, in a state in which a RTS has not been transmitted to the access point 101, receives a CTS that is transmitted from the access point 101 and addressed to the guard terminal 102a, namely, the CTS in which the address of the terminal 102a is set in the RA field, the guard terminal 102a transmits to the guard terminal 102b a CTS packet in which the same value as the NAV included in the received CTS packet is set. At this time, the value of the RA field of the CTS packet is set to the address of the guard terminal 102b.

Similarly, in a case that the guard terminal 102b, in a state in which a RTS packet is not transmitted, receives a CTS packet in which the RA field is set to the address of the guard terminal 102b is received, the guard terminal 102b transmits a CTS packet in which a NAV having the same value as the NAV set in the received CTS packet is set and the RA field is set to the guard terminal 102c. In a case that the guard terminal 102c, in a state in which a RTS packet is not transmitted, receives a CTS packet in which the address of the guard terminal 102c is set, the guard terminal 102c transmits a CTS packet in which a NAV having the same value as the NAV set in the received CTS packet is set and the address of the guard terminal 102d is set in the RA field. In a case that the guard terminal 102d being supposed to transmit the NAV latest, in a state in which a RTS packet is not transmitted, receives a CTS packet in which the address of the guard terminal 102d is set in the RA field, the guard terminal 102d transmits the same packet as the received CTS packet, namely, a CTS packet in which the RA field is set to the address of the guard terminal 102d, or a CTS packet similar to the CTStoSelf. As described above, each of the guard terminals 102a to 102d transmits a CTS packet after interpreting the received CTS packet, thus allowing all the guard terminals to transmit the NAV configured by the access point 101.

In addition, the guard terminals 102a to 102d receive the power control command transmitted from the monitoring terminals 103a to 103d, and change the transmission power in a case of transmitting the NAV. In a case that an increase of the transmission power is indicated by the monitoring terminals 103a to 103d, the guard terminals that have received the power control command increase the transmission power by adding a power of a predetermined value unless a prescribed upper limit is reached. The power control command may include an amount of incremental transmission power, and the transmission power may be increased according to the amount of the incremental transmission power. In a case that the transmission power after the change exceeds the prescribed upper limit, the guard terminal that has received the power control command may configure the transmission power to the specified value. Similarly, in a case that a decrease of the transmission power is indicated by the monitoring terminals 103a to 103d through the power control command, the guard terminals 102a to 102d may decrease the transmission power. A predetermined value may be subtracted from the transmission power, or a value indicated by the power control command may be used. Further, a lower limit of the transmission power may be configured. The transmission power may be configured to the lower limit in a case that the transmission power falls below the lower limit as a result of the power control.

An example flow of processing, including such processing, which is related to the NAV transmission by a guard terminal will be described with reference to FIG. 7. The flow of the processing of the guard terminal starts from S701. In S702, the guard terminal configures the transmission power in transmitting a NAV to the initial value.

Subsequently, in S703, the guard terminal performs carrier sense. In S704, the guard terminal determines whether a carrier is detected. In a case that the carrier is not detected, the process returns to S703. In a case that the carrier is detected, the process proceeds to S705, and the guard terminal performs demodulation with the assumption that a packet is included in the received signal. In a case that the guard terminal determines, in S706, that the demodulation of the packet has failed, the process returns to S703. In a case that it is determined, in S706, that the packet has been successfully demodulated, the guard terminal determines, in S707, whether the received packet is a CTS packet that includes the NAV to be transmitted. In a case that the guard terminal determines, based on the RA field included in the CTS packet, that the packet includes the NAV to be transmitted, the process proceeds to S708, otherwise the process proceeds to S709.

In S708, the guard terminal transmits a CTS packet in which a NAV is configured by using the predetermined value of the RA field and the value of the NAV included in the received CTS, and then the process returns to S703. In S709, the guard terminal determines whether the received packet includes a power control command, and in a case that it determines that the power control command is not included, the process returns to S703. In a case that it is determined that the power control command is included, the process proceeds to S710, the transmission power for transmitting the CTS packet including the NAV is reconfigured, and the process returns to S703. Such an operation of the flow relating to the NAV transmission enables the guard terminal 103a to 103d to perform the above-described operation.

The monitoring terminals 103a to 103d determine whether the reception strength of the NAV transmitted from the guard terminals 102a to 102d is within the prescribed range, and in a case that it is out of the prescribed range, the monitoring terminals 103a to 103d transmit power control commands to the guard terminals 102a to 102d. The monitoring terminals 103a to 103d may indicate only an increase/decrease of the transmission power by the power control command, or may also indicate an increment/decrement in the transmission power. Also, the absolute value of the transmission power may be indicated. Each of the monitoring terminals 103a to 103d may transmit the power control command to the closest one of the guard terminals 102a to 102d. In FIG. 1, the monitoring terminal 103a transmits the power control command to the guard terminal 102a, the monitoring terminal 103b transmits the power control command to the guard terminal 102b, the monitoring terminal 103c transmits the power control command to the guard terminal 102c, and the monitoring terminal 103d transmits the power control command to the guard terminal 102d.

These are merely examples, and the transmission destination of the power control command may not be uniquely determined. A plurality of monitoring terminals may transmit power control commands to a plurality of guard terminals. For example, in a case that the number of monitoring terminals is larger than the number of guard terminals, a plurality of monitoring terminals may transmit the power control commands to one guard terminal. Further, in a case that the number of monitoring terminals is smaller than the number of guard terminals, one monitoring terminal may transmit the power control commands to a plurality of guard terminals. The guard terminal to which the monitoring terminal transmits the power control command may be determined in advance by the access point 101 or the like, or may be dynamically changed, depending on the strength of the signal received by the monitoring terminal, by using a method, for example, in which the power control command is transmitted to the guard terminal that has the strongest signal. As a method of measuring the reception strength by using the monitoring terminal, the power of the received signal may be directly measured, or the error rate of the CTS packet including the NAV may be measured and used as the reception strength.

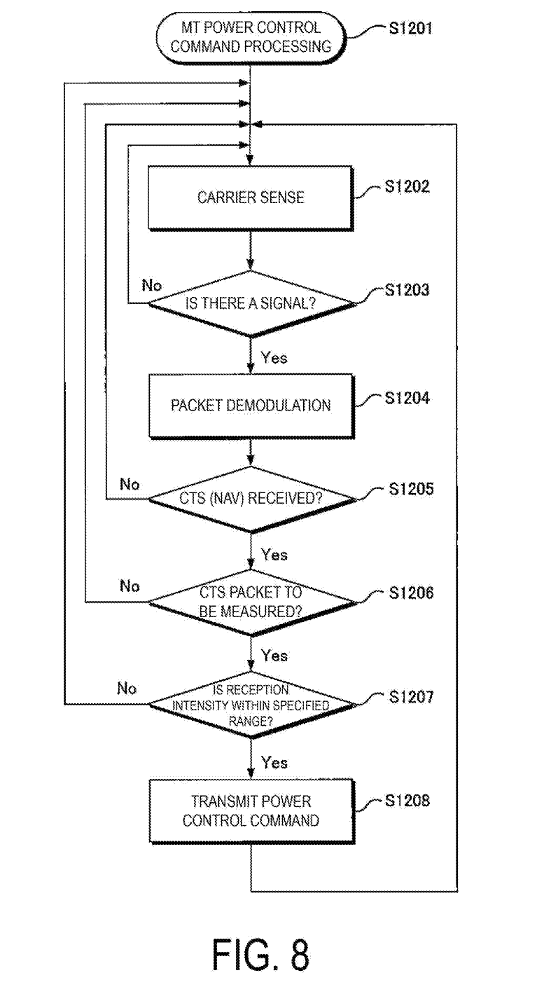

An example flow of processing a power control command by the monitoring terminal will be described with reference to FIG. 8. The flow starts from S1201, and in S1202, carrier sense is performed and the monitoring terminal checks whether a signal is received. In S1203, in a case that the monitoring terminal does not determine that a signal is received, the process returns to S1202, and in a case that it determines that a signal is received, then the process proceeds to S1204. In S1204, the monitoring terminal demodulates a signal with the assumption that the signal received includes a packet. In S1205, whether the demodulated packet is a CTS packet that includes the NAV is checked. The process returns to S1202 in a case that the packet is not the CTS packet, or the demodulation has failed. The process proceeds to S1206 in a case that the packet is the CTS packet. In S1206, whether the received packet is a CTS packet transmitted from a target of the reception strength control is determined. The process returns to S1202 in a case that the received packet is not the CTS packet from the target, and proceeds to S1207 in a case that the received packet is the CTS packet from the target. In S1207, the monitoring terminal determines the reception strength of the measurement target. The process returns to S1202 in a case that the reception strength is within the prescribed range, and proceeds to S1208 in a case the reception strength is out of the prescribed range. In S1208, a power control command based on the measured reception strength is transmitted to the guard terminal that has transmitted the CTS packet, and the process returns to S1202. The operation as described above enables control of the transmission power of the guard terminal even in a case of a propagation state change, which is, for example, a case that a large vehicle stops near the guard terminal. This enables the control of the coverage of the NAV.

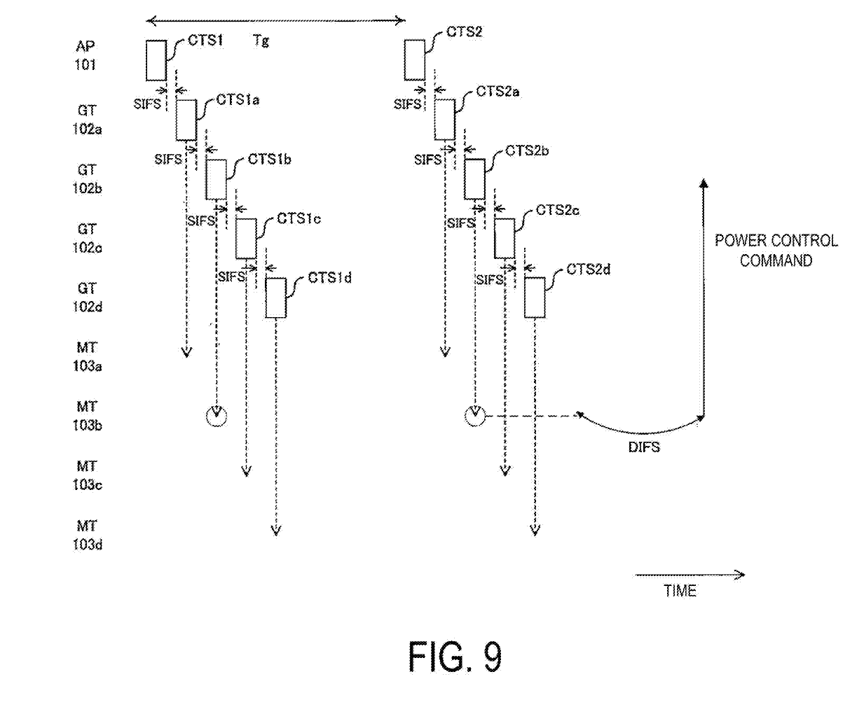

FIG. 9 is a timing chart illustrating an example of the above operation. AP stands for access point, GT stands for guard terminal and MT stands for monitoring terminal. The access point 101 transmits a CTS packet including a NAV for medium reservation at an interval Tg. In FIG. 9, two transmissions of a CTS packet are illustrated. The CTS packet in the first transmission is referred to as CTS1, and the CTS packet in the second transmission is referred to as CTS2. In a case that the NAV included in this CTS packet is configured to be longer than Tg, opportunities of transmission by the terminal which is not connected to the access point 101 can be significantly reduced. The guard terminal 102a, which has received the CTS1a, transmits the CTS1a after the Short InterFrame Space (SIFS) specified in the standard 802.11 elapses.

The monitoring terminal 103a measures the transmission strength of the CTS1a, confirms that it is within the prescribed range, and does not transmit anything. The guard terminal 102b, which has received the CTS1a, transmits the CTS1b after the SIFS elapses. The monitoring terminal 103b measures the transmission strength of the CTS1b, confirms that it is within the prescribed range, and does not transmit anything. The guard terminals 102c and 102d, and the monitoring terminals 103c and 103d also operate in a similar manner. Each apparatus operates similarly for the CTS2, and an example is illustrated, in which the monitoring terminal 103b detects that the transmission strength of the CTS2b is out of the prescribed range and transmits the power control command to the guard terminal 102b. The monitoring terminal 103b waits for the completion of the transmission of the CTS2d, then waits during the DIFS interval before the transmission of the power control command by using the normal DCF protocol, and then transmits the power control command.

In the present embodiment, a control of the NAV transmission by the guard terminals 102a to 102d is performed, between the access point 101 and the guard terminals 102a to 102d, by using a frequency at which the terminal performs a communication. However, the control may be performed by using another method, which is, for example, a radio communication path at a different frequency. In addition, in the present embodiment, multiple guard terminals 102a to 102d sequentially transmit the NAVs, but they may be controlled so as to transmit the NAVs simultaneously.

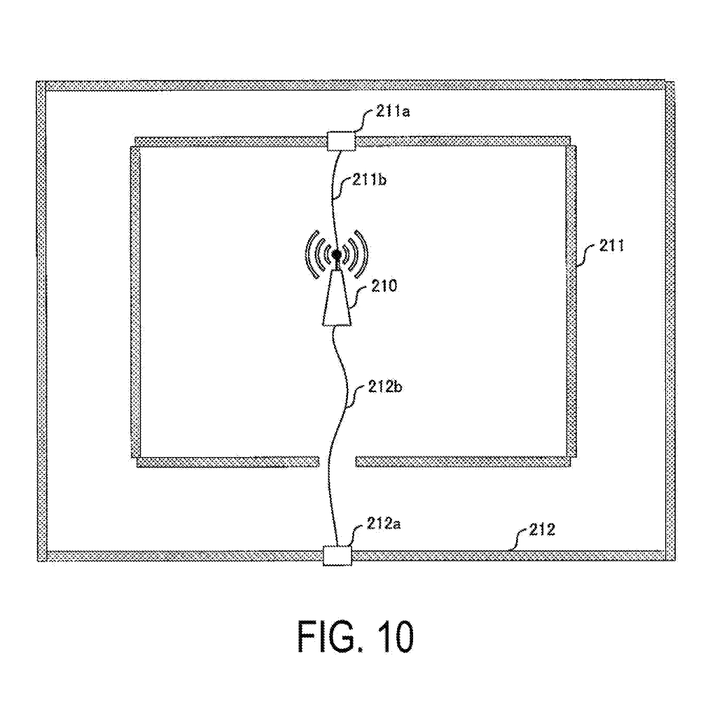

In the embodiment, as illustrated in FIG. 1, an example configuration is described that includes one access point, four guard terminals, four monitoring terminals, and an LCX connected to each of the guard terminals and the monitoring terminals. However, the guard terminals and the monitoring terminals may be omitted and the LCX for transmitting the NAV for medium reservation and the LCX for monitoring may be directly connected to the access point. An example of such a configuration is illustrated in FIG. 10. Reference sign 210 is an access point, reference sign 211 is a LCX for transmitting the NAV, reference sign 211a is a feeding point to the LCX 211, reference sign 211b is a coaxial cable for connecting the feeding point 211a and the access point 210, reference sign 212 is a LCX for monitoring, reference sign 212a is a feeding point to the LCX 212, and reference sign 212b is a coaxial cable for connecting the feeding point 212a and the access point 210. With such a configuration, since a communication between the access point and the guard terminal is not necessary, the medium reservation can be performed with only one-time transmission by the access point 210. In FIG. 10, the LCX 211 for transmitting the NAV is linearly arranged. The LCX 211 may be configured to transmit the NAV in a planar manner by using the mesh LCX.

The access point 101, the guard terminals 102a to 102d, and the monitoring terminals 103a to 103d operate as described above, and the NAV is periodically transmitted in a desired range by using the arranged LCX thus making it possible to have an effect of the medium reservation for the terminal connected to the access point 101.

### Second Embodiment

In the embodiment, an example configuration will be described, in which the guard terminal transmits the NAV not only in a reactive manner according to an indication from the access point but also in an active manner, and the access point adaptively controls the frequency of NAV transmission without a continuous and periodical transmission of the NAV.

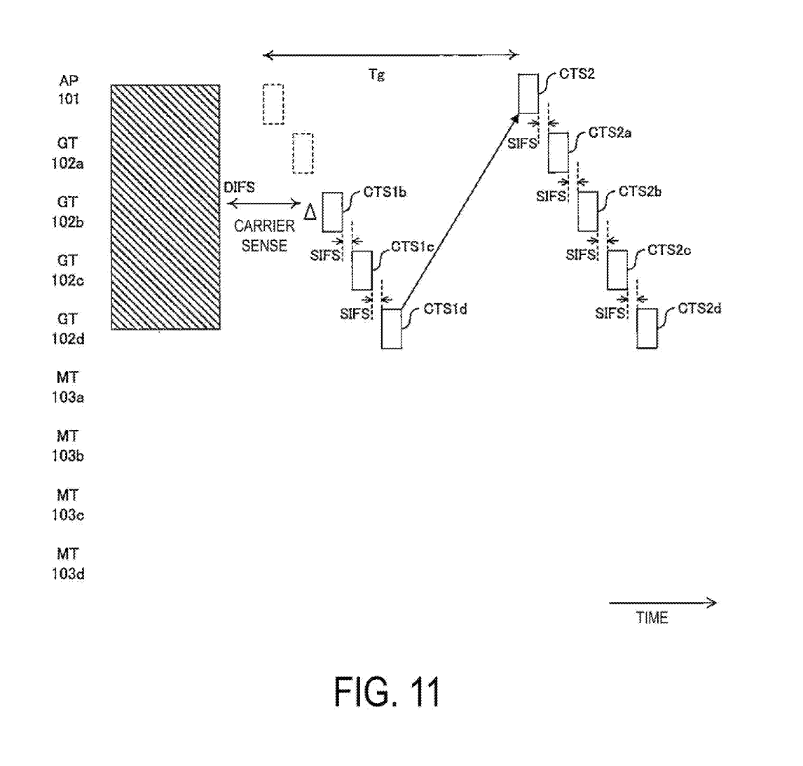

In the embodiment, the same equipment as the equipment used in the first embodiment is used. The guard terminal monitors the NAV that the access point periodically transmits for medium reservation. In a case that it is determined that the NAV periodically transmitted by the access point for the medium reservation has not been transmitted for some reason, the guard terminal transmits a CTS packet including the NAV for the medium reservation after performing carrier sense. A timing chart illustrating an example of this operation is indicated in FIG. 11. A state is illustrated, in which the NAV for the medium reservation has not been transmitted by the access point 101 and the guard terminal 102a because the medium is used by another terminal (shaded parts). The guard terminal 102b detects completion of the use of the medium, and then in a case that the CTS packet periodically transmitted from the access point 101 is not received, performs the carrier sense after a DIFS interval subsequent to the completion of the use of the medium. After confirming that the medium is not used, the guard terminal 102b transmits a CTS packet that includes the NAV for the medium reservation.

As a value of the NAV to be included in the CTS packet, the value of the NAV most recently used by the access point 101 for the medium reservation may be used. Further, in some cases, the guard terminal may use a value different from the value of the NAV used by the access point 101. Examples of such cases include a case of a transmission at a timing later than the timing of periodical transmission of the NAV by the access point 101 for the medium reservation, and a case in which the guard terminal transmits the NAV for the medium reservation after performing carrier sense. The operations of the other guard terminals are similar to the operations in the first embodiment. In the case illustrated in FIG. 11, the operations of the guard terminal 102c and the guard terminal 102d are similar to the operations in the first embodiment.

In a case that the guard terminal has transmitted the NAV for medium reservation while the access point 101 has not transmitted the NAV for its own medium reservation, the access point 101 may resume a transmission of the NAV for medium reservation at a timing similar to the timing in case of transmitting the NAV for its own medium reservation. In FIG. 11, an example is illustrated, in which the access point 101 calculates, based on the period when the guard terminal 102d transmitted the NAV, a timing similar to the timing in a case of transmitting the NAV for its own medium reservation, and transmits a CTS2. After the access point 101 has transmitted the CTS2, the other guard terminals 102a to 102d operate similarly to those in the first embodiment.

In a case that the amount of communication by the terminal connected to the access point 101 is adequately small and it is determined that the transmission of the NAV for medium reservation is unnecessary, the access point 101 may temporarily stop the transmission of the NAV for the medium reservation. In a case that the guard terminals 102a to 102d actively transmit the NAV for the medium reservation by using carrier sense, the access point 101 needs to notify to the guard terminals 102a to 102d that the transmission of the NAV for the medium reservation is temporarily stopped. Various methods can be used as the notification method. Examples of the method that can be used include a method of transmitting a CTS packet in which the value of the NAV is set to 0 from the access point 101 one to several times, and a method of indicating to each of the guard terminals 102a to 102d by using a power control command. In a case that the transmission of the NAV for the medium reservation becomes necessary, and that the access point 101 resumes an operation similar to the operation in the first embodiment, the guard terminals 102a to 102d can detect the NAV transmission for the medium reservation, and also resume an operation similar to the operation in the first embodiment. It is thought that examples of a case in which the NAV transmission for the medium reservation is necessary, may include a case of an increase in the amount of the communication of the terminal that is connected to the access point 101, and a case of an increase in the amount of the communication of the terminal that is not connected to the access point 101.

The operation as described above enables the guard terminal to transmit the NAV for the medium reservation even in a case that an indication for transmitting the NAV for the medium reservation from the access point to the guard terminal has failed. Further, in a case that a frequency of communication is reduced and a medium reservation is not necessary, a transmission of the NAV for the medium reservation may be temporarily suspended and resumed when necessary.

### Third Embodiment

In the embodiment, an example of a case will be described, in which a transmission of a NAV for a medium reservation is controlled by using QoS (Quality of Service) of a terminal connected to the access point 101. In the embodiment, the equipment to be used is the same as the equipment in the first embodiment.

Two types of terminals may be connected to the access point 101. One type of terminal can recognize the NAV for medium reservation transmitted from the guard terminals 102a to 102d, and another type of terminal cannot recognize the NAV for medium reservation, and instead recognizes a NAV as the NAV for starting a normal communication. In a case of providing QoS to the terminal capable of recognizing the NAV for medium reservation transmitted from the guard terminals 102a to 102d, the medium reservation is performed in a manner similar to the manner in the first embodiment, and a communication using the reserved medium allows the QoS to be secured. However, the terminal that cannot recognize the NAV for medium reservation and recognizes a NAV as the NAV for starting normal communication is likely to determine that a transmission opportunity is not obtainable, and so the QoS is not likely to be satisfied. In a case that such a terminal is connected to the access point 101, the NAV needs to be shortened for a terminal for which QoS is provided.

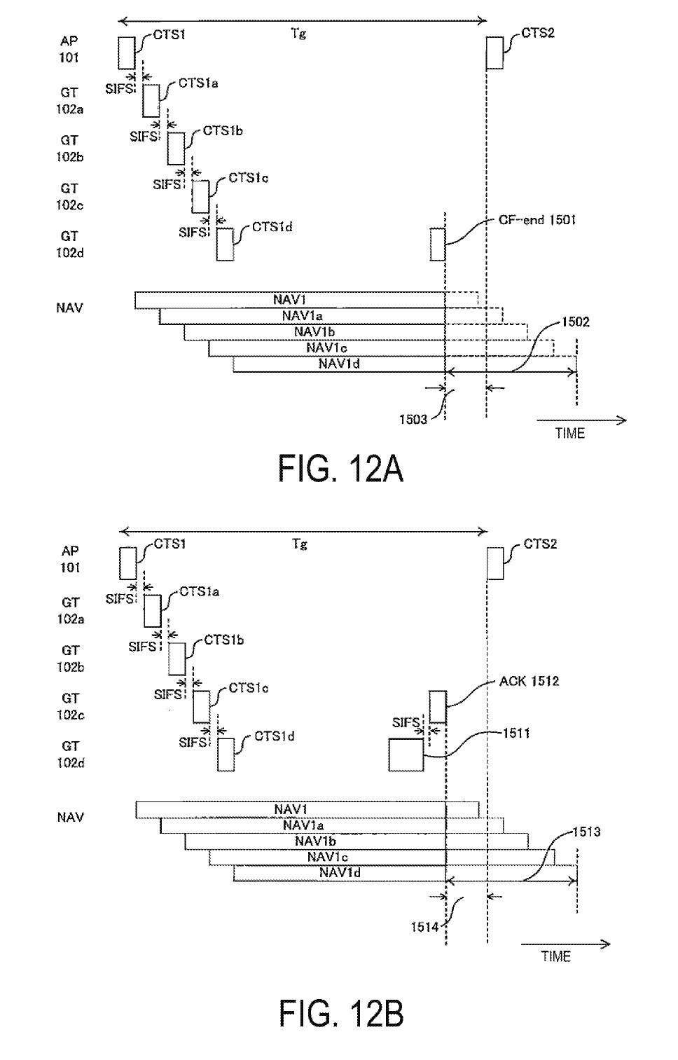

In the embodiment, there are two methods for shortening the NAV configured for medium reservation. In one method, a CF-end packet is transmitted. In the other method, a communication apparatus corresponding to the address of the RA field of the CTS packet most recently transmitted, which is the guard terminal that has transmitted the CTS packet most recently in a case of the example illustrated below, transmits a short packet to another communication apparatus such as another guard terminal or the access point 101, and receives an ACK to be transmitted from the communication apparatus. FIG. 12A illustrates an example case of using the CF-end packet, and FIG. 12B illustrates an example case of using the short packet.

In the example of FIG. 12A, the access point 101 and the guard terminals 102a to 103d transmit NAV1 to NAV1d. The transmissions of NAV1 to NAV1d may be performed by using the method described in the first or second embodiment. The NAV1 to NAV1d are shortened by the CF-end packet 1501. The shortened period is indicated by reference sign 1502. Since the access point 101 transmits the NAV for medium reservation at the interval Tg, the period 1503, being a part of the shortened period 1502, after which a CTS2 is transmitted, allows another terminal to obtain a transmission opportunity.

In FIG. 12A, the guard terminal 102d transmits the CF-end packet 1501. Since a CF-end packet has the same effect for the communication apparatus capable of using the BSSID of the same BSS, an apparatus other than the guard terminal 102d can transmit the CF-end packet 1501. Also, a CF-end-CF-Ack packet, which has the same effect as the CF-end packet, may be used. In the example of FIG. 12B, the access point 101 and the guard terminals 102a to 103d transmit NAV1 to NAV1d. The transmissions of NAV1 to NAV d may be performed by using the method described in the first or second embodiment. The NAV1 to NAV1d are shortened by Ack packet 1512 that the guard terminal 102c transmits to the guard terminal 102d. In order to cause this ACK packet 1512 to be transmitted, the guard terminal 102d transmits a short packet 1511 to the guard terminal 103c. The content of the short packet 1511 is not particularly limited, and it may be used for a control other than the control of a NAV.

In addition, since the NAV can be also shortened, without transmitting a short packet, in a case that a communication apparatus transmits an ACK packet to the guard terminal 102d, it may be configured such that only the ACK packet is transmitted. The NAV is also reconfigured by using the Duration field configured in the short packet 1511. Since it is defined to wait for a period of SIFS in a case that an ACK is not received after the short packet, a shortened period cannot be clearly defined. The period 1514, during which a transmission period is provided to another terminal, is better clarified by causing one of the terminals to transmit an ACK to explicitly shorten the NAV.

A transmission period of a communication apparatus that performs a transmission is variable during the period 1503 or 1514, which is a period in which another communication apparatus obtains a transmission period. It may be difficult for the access point 101 to secure the QoS in a case that a long transmission is frequently performed.

The access point 101 measures the transmission period of the communication apparatus that starts the transmission during the period 1503, or 1514. In a case that it is determined that the QoS provided is unsatisfactory, the access point 101 may stop providing a period such as period 1503, or 1514, obtained by shortening the NAV, that provides a transmission opportunity to other communication apparatuses. In addition, a period for giving a transmission opportunity to other communication apparatuses may be provided only in a case that the QoS is not provided, and may not be provided in a case that the QoS is provided.

The operation described above enables the quality to be improved in providing the QoS.

### Fourth Embodiment

In the embodiment, an example case is described in which in a case that the access point has less opportunities of transmitting a NAV for medium reservation due to a transmission by a terminal or the like that is not connected to the access point, a new medium reservation is performed in another frequency channel, and a subsequent communication is performed in the other frequency channel. In the embodiment, an equipment to be used is the same as the equipment in the first embodiment.

In the embodiment, for example, in a case that the access point 101 determines that opportunities of transmitting a NAV for medium reservation are not sufficiently obtained, or the monitoring terminals 103a to 103d detect a transmission by a terminal apparatus other than the terminal apparatus continuously connected to the access point 101, the access point 101 causes the monitoring terminals 103a to 103d to measure the state of the frequency channel other than the frequency channel currently used, and select one of the frequency channels measured, for example, the frequency channel with the lowest rate of time utilization. The access point 101 causes the guard terminals 102a to 102d to transmit a NAV for medium reservation in the selected frequency channel, and then causes the monitoring terminals 103a to 103d to measure the selected frequency channel to determine whether the medium reservation is operational. After confirming that it is sufficiently operational, the access point 101 notifies, to the terminals connected to the access point 101 and the monitoring terminals 103a to 103d, the shift to the selected frequency channel. An example of the procedure will be described with reference to the timing chart of FIG. 13.

Prior to the frequency channel shift, the access point 101 indicates to the monitoring terminals 103a to 103d a measurement of a frequency channel other than the frequency channel currently used. Reference sign 1601a is an indication of the frequency channel measurement to the monitoring terminal 103a, reference sign 1601b is an indication of the frequency channel measurement to the monitoring terminal 103b, reference sign 1601c is an indication of the frequency channel measurement to the monitoring terminal 103c, and reference sign 1601d is an indication of the frequency channel measurement to the monitoring terminal 103d. Although the indication method is not specifically designated, as an example, the procedure of the Channel Load Report, which is a measurement standardized in the IEEE 802.11, may be used.

The monitoring terminals 103a to 103d that have received the measurement indications report the measurement results to the access point 101 as soon as the measurement of another frequency channel is completed. The monitoring terminal 103a measures another frequency channel in the period 1602a, and notifies the measurement result to the access point 101 in 1603a. The monitoring terminal 103b measures another frequency channel in the period 1602b, and notifies the measurement result to the access point 101 in 1603b. The monitoring terminal 103c measures another frequency channel in the period 1602c, and notifies the measurement result to the access point 101 in 1603c. The monitoring terminal 103d measures another frequency channel in the period 1602d, and notifies the measurement result to the access point 101 in 1603d.

After receiving the measurement results of the other frequency channels, the access point 101 selects a measurement result of a frequency channel among the obtained measurement results. The frequency channel that facilitates medium reservation may be selected. As an example, a method may be used that selects a frequency channel having the smallest average value of Channel Road among the frequency channels of which the Channel Load Reports have been transmitted from the monitoring terminals 103a to 103d. Thereafter, the selected frequency channel is notified to the guard terminals 102a to 102d by using the messages 1604a to 1604d. The guard terminals 102a to 102d that have been notified of the new frequency channel shift to the notified frequency channel, and start transmission of the NAV for medium reservation. At this time, since the access point 101 has not shifted to the notified frequency channel, the guard terminals 102a to 102d perform the carrier sense by themselves and transmit the NAV for medium reservation. Although the transmission method is not specifically designated, the method described in the second embodiment may be used as an example.

After notifying the frequency channel to the guard terminals 102a to 102d, the access point 101 indicates to the monitoring terminals 103a to 103d a measurement of the frequency channel notified to the guard terminals 102a to 102d. Although the method of indicating the measurement is not specifically designated, the reporting of the Channel Load Report of the frequency channel may be indicated, as an example. In FIG. 13, a measurement of the frequency channel is indicated to the monitoring terminal 103a through a message 1605a, and the monitoring terminal 103a performs the measurement of the indicated frequency channel in the period 1606a, then shifts to the original frequency channel and notifies a result of the measurement to the access point 101 in 1607a. In addition, a measurement of the frequency channel is indicated to the monitoring terminal 103a through a message 1605b, and the monitoring terminal 10b performs the measurement of the indicated frequency channel in the period 1606b, then shifts to the original frequency channel and notifies a result of the measurement to the access point 101 in 1607b. In addition, a measurement of the frequency channel is indicated to the monitoring terminal 103a through a message 1605c, and the monitoring terminal 103c performs the measurement of the indicated frequency channel in the period 1606c, then shifts to the original frequency channel and notifies a result of the measurement to the access point 101 in 1607c. In addition, a measurement of the frequency channel is indicated to the monitoring terminal 103a through a message 1605d, and the monitoring terminal 103d performs the measurement of the instructed frequency channel in the period 1606d, then shifts to the original frequency channel and notifies a result of the measurement to the access point 101 in 1607d.

The access point 101 checks the messages 1607a to 1607d and in a case it determines that the medium reservations of the guard terminals 102a to 102d in the frequency channel designated for the guard terminals 102a to 102d are more effective than the medium reservations in the frequency channel currently used, the access point 101 transmits the message 1608 to the terminals connected to the access point 101 to indicate a shift to the frequency channel designated for the guard terminals 102a to 102d.

Although the method of moving to another frequency channel is not particularly specified, a Channel Switch message of IEEE 802.11 or the like can be used as an example. In a case that the access point 101 determines that the medium reservations of the guard terminals 102a to 102d in the frequency channel designated for the guard terminals 102a to 102d are less effective, the access point 101 does not shift to another frequency channel. At this time, the frequency channel in which the guard terminals 102a to 102d transmit the NAV for medium reservation is restored to the original one. Although the method for the restoring is not specifically designated, the access point 101 may temporarily shift the frequency channel, and indicate to the guard terminals 102a to 102d a shift of the frequency channel, or in a case that there is no signal from the access point 101 for a prescribed period, the guard terminals 102a to 102d may shift to the original frequency channel.

The access point 101, the guard terminals 102a to 102d, and the monitoring terminals 103a to 103d operate as described above to enable the medium reservation to be more effective for the terminals connected to the access point 101.

### Fifth Embodiment

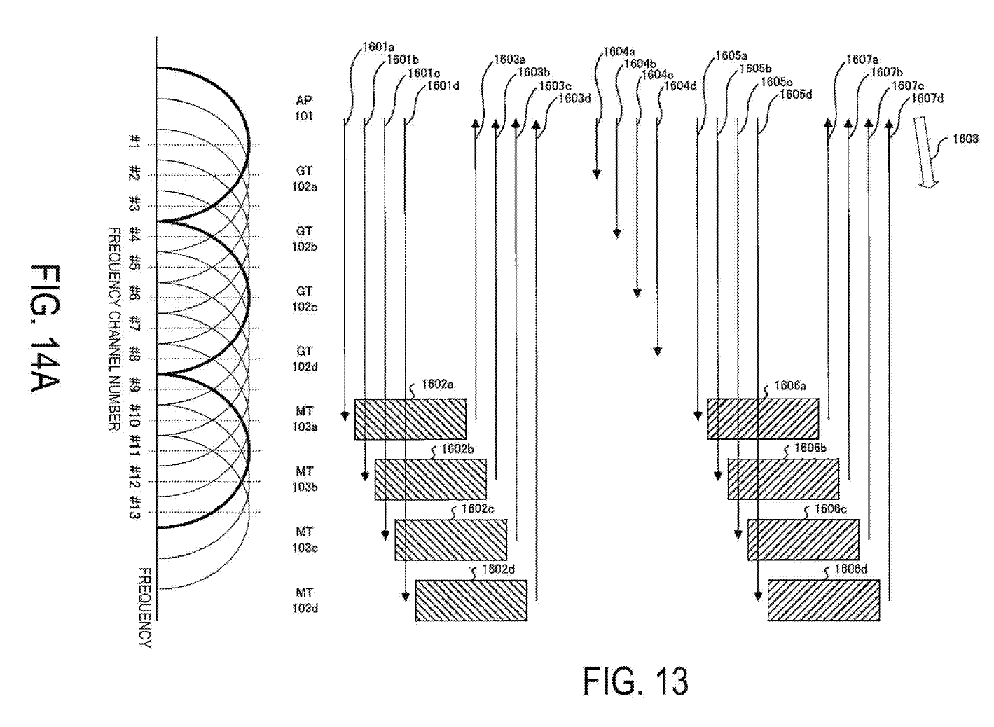

In the embodiment, an example will be described in which medium reservations are performed for a plurality of frequency channels by the guard terminal. The NAV transmission for medium reservation may not work effectively in a case that the frequency band occupied for a communication is wide, in a certain frequency channel, with respect to the frequency channel interval. An example of such a case is a channel utilization method in the scheme of IEEE 802.11b/g, and the outline is illustrated in FIG. 14A. While the frequency channels are allocated at an interval of 5 MHz, approximately 22 MHz band is occupied in the scheme of IEEE 802.11b, and approximately 20 MHz band is occupied in the scheme of IEEE 802.1 in. For example, an apparatus may perform a communication by using the channel #6, and another apparatus may perform a communication by using the frequency channel #2, #3, #4, #5, #7, #8, #9, or #10. In such a case, an interference may occur with each other even though the apparatus cannot communicate with the other apparatus.

Therefore, in a case that a NAV for medium reservation is transmitted in the frequency channel #6, the NAV cannot be recognized in other frequency channels, and terminals using other frequency channels start transmissions only by using carrier sense. The interference between two increases in a case that the two apparatuses use frequency channels that have a wide overlapping band. The interference with the apparatus using the adjacent frequency channel #5, or #7 is large, and next to that, the interference with the apparatus using the frequency channel #4, or #8 is large. In the embodiment, the NAV for medium reservation is transmitted in a frequency channel that has such a large influence, thus reducing an interference generated from an apparatus using such frequencies.

In the embodiment, an equipment to be used is the same as the equipment in the first embodiment. An example of a control in the embodiment will be described with reference to a timing chart in FIG. 14B. The access point 101, the guard terminals 102a to 102d, the monitoring terminals 103a to 103d, and the terminals connected to the access point 101 communicate in the period 1701 by using the frequency channel #6. In the period 1701, similarly to the first embodiment, the guard terminals 102a to 102d may transmit the NAV for medium reservation in the frequency channel #6. Next, in the period 1702, the guard terminals 102a to 102d transmit the NAV for medium reservation in the frequency channel #5. The method of transmission is not particularly specified, but the method described in the second embodiment may be used as an example. Similarly, the method described in the second embodiment may be used as an example in a case of transmitting the NAV for medium reservation in a frequency channel other than the frequency channel #6. Subsequently, in the period 1703, the guard terminals 102a to 102d transmit the NAV for medium reservation in the frequency channel #7.

In the period 1704, similarly to the period 1701, the access point 101, the guard terminals 102a to 102d, the monitoring terminals 103a to 103d, and the terminals connected to the access point 101 communicate by using the frequency channel #6. Subsequently, the guard terminals 102a to 102d transmit the NAV for medium reservation in the frequency channel #4 in the period 1705, and transmit the NAV for medium reservation in the frequency channel #8 in the period 1706. Thereafter, in the period 1707, similarly to the period 1701, the access point 101, the guard terminals 102a to 102d, the monitoring terminals 103a to 103d, and the terminals connected to the access point 101 communicate by using the frequency channel #6. Subsequently, the guard terminals 102a to 102d transmit the NAV for medium reservation in the frequency channel #5 in the period 1708, and transmit the NAV for medium reservation in the frequency channel #7 in the period 1709. The flow described above is repeated to transmit the NAV for medium reservation in the frequency channels #4, #5, #7, and #8, adjacent to the frequency channel #6 to be used for communication, which have large interference. The interference is reduced because the transmission opportunities in the frequency channels are decreased. In addition, the NAV for medium reservation is more frequently transmitted in the frequency channels #5 and #7 that have larger interference to further reduce the interference.

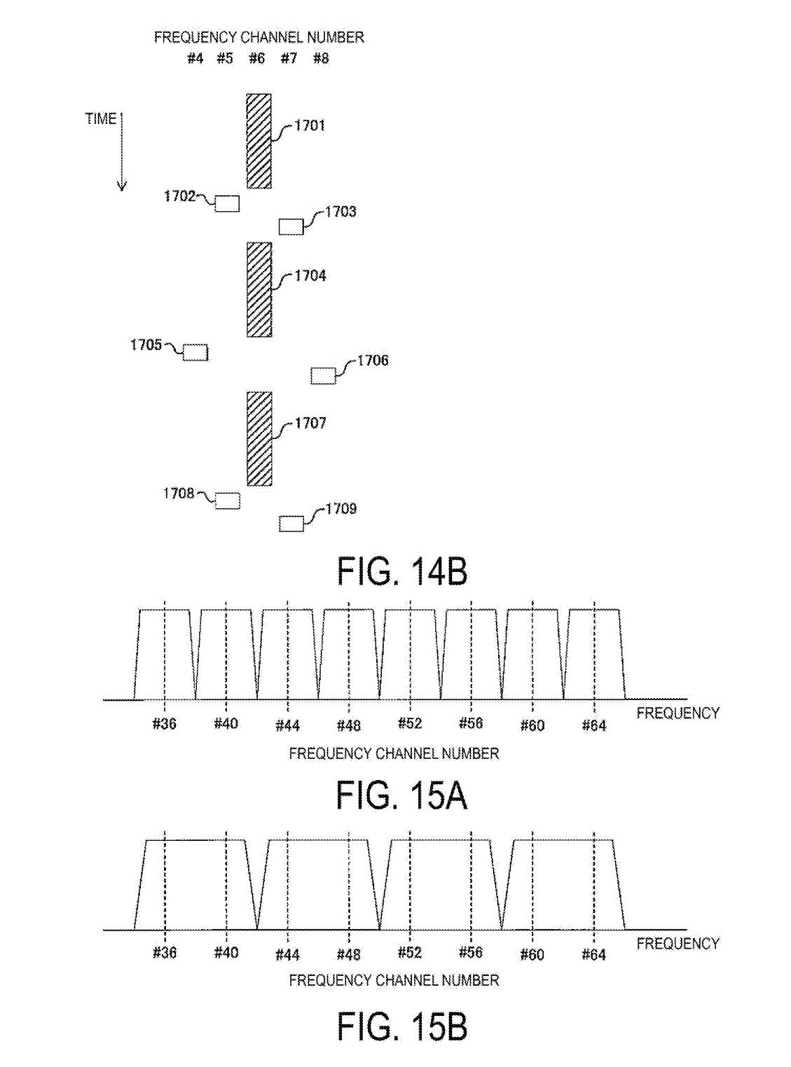

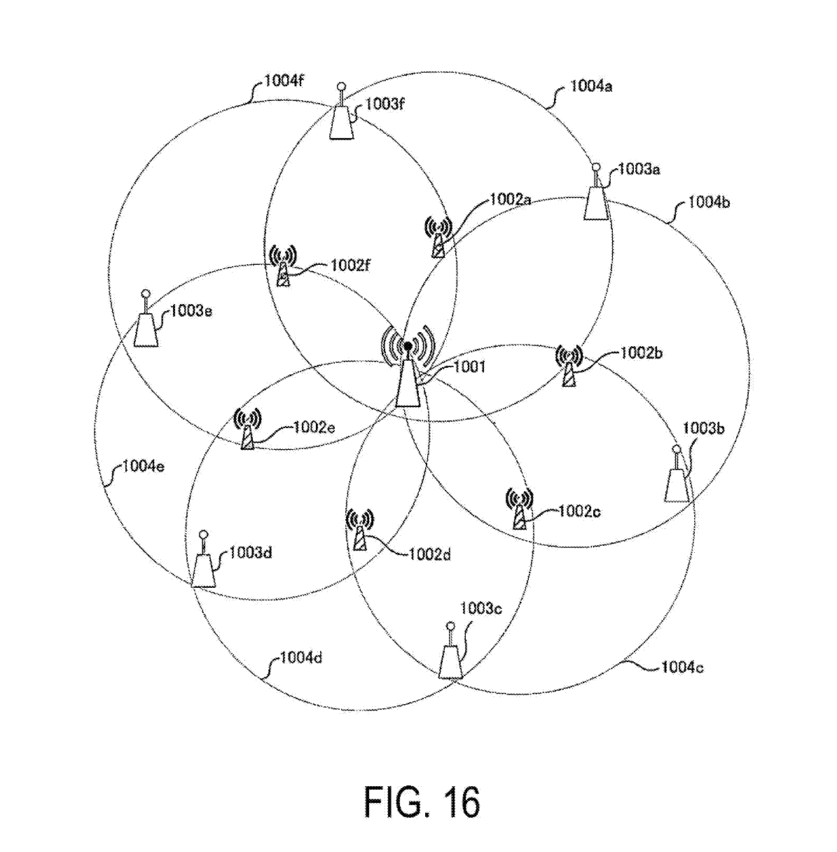

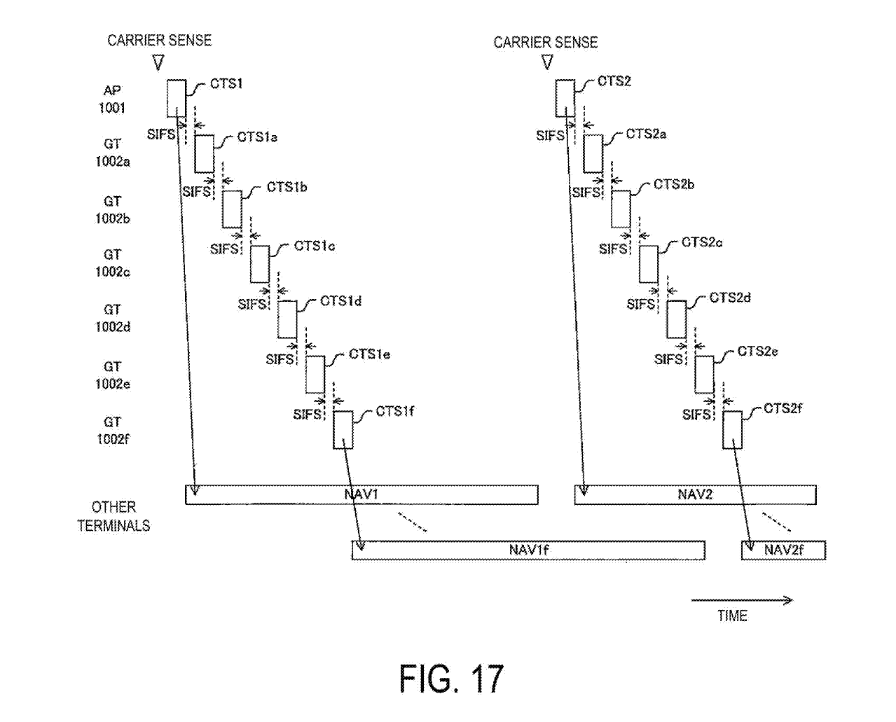

Also, even in a case that the occupied bands of the frequency channels do not overlap, the NAV for medium reservation may be transmitted in the adjacent frequency channels. Depending on various factors such as a frequency channel allocation, an occupied band per frequency channel, a performance of a receiving unit, and the like, in a case that in the vicinity of a communication apparatus, another communication apparatus performs a transmission by using a frequency channel adjacent to the frequency channel used by the communication apparatus, the adjacent frequency channel may cause an interruption. To reduce the interruption, the procedure described in FIGS. 14A and 14B may be used. As an example, it is assumed that the frequency channel to be used and the occupied band per frequency are configured as illustrated in FIG. 15A. In a case that the access point 101 uses the frequency channel #44, an interruption may be caused by another apparatus using the frequency channel #40 or the frequency channel #48. As an example of a method of transmitting the NAV for medium reservation, a procedure illustrated in FIG. 14B may be used, in which the frequency channel #6 is replaced by the frequency channel #44, the frequency channel #4 or the frequency channel #5 is replaced by the frequency channel #40, and the frequency channel #7 or the frequency channel #8 is replaced by the frequency channel #48.

In addition, a method of bundling a plurality of frequency channels to achieve a high speed channel is often used, and interference may occur between a communication apparatus in which a plurality of frequency channels are bundled and a communication apparatus that does not use the plurality of frequency channels. For example, in a case that two frequency channels are bundled for use as illustrated in FIG. 15B, an apparatus that uses only the frequency channel #48 causes interference to an apparatus that uses the frequency channel #48 bundled with the frequency channel #44. In order to reduce the interference, an access point using the frequency channel #48 for the frequency channel #44 may transmit the NAV for medium reservation in the frequency channel #48. Similarly, in a case of bundling four frequency channels, in which the frequency channels #36, #40, and #48 are bundled with the frequency channel #44 for example, the NAV for medium reservation may be transmitted in the frequency channels #36, #40, and #48.

In the procedure illustrated in FIG. 14B, in a case that the NAV for medium reservation is transmitted in a plurality of adjacent frequency channels, the NAV for medium reservation is transmitted in each frequency channel one by one, but the NAV for medium reservation may be transmitted in the plurality of frequency channels at once.

The operating described above enables the interference received from the adjacent frequency channels to be reduced, and the transmission opportunities to be increased. This allows communication efficiency to be improved.

Note that the present invention can adopt the following configuration. Namely, according to one aspect of the present invention, provided is a guard terminal that is used with an access point for communicating with a wireless terminal apparatus, includes a leaky coaxial cable and transmits a signal for medium reservation from the leaky coaxial cable.

Further, according to another aspect of the present invention, provided is a guard terminal apparatus of which the leaky coaxial cable is arranged in a part of a coverage of an access point.

Further, according to another aspect of the present invention, provided is a wireless communication apparatus that is used with an access point and a guard terminal apparatus, and does not perform a medium reservation using a medium reservation signal in a case that an address included in the medium reservation signal transmitted by the guard terminal apparatus is a prescribed value.

Further, according to another aspect of the present invention, provided is a guard terminal apparatus that is used with an access point for communicating with a wireless terminal apparatus, and transmits a signal to shorten a reserved period based on a medium reservation signal transmitted by the guard terminal apparatus.

Further, according to another aspect of the present invention, provided is an access point that is used with a wireless terminal apparatus and a guard terminal apparatus, and transmits a signal for shortening a reserved period based on a medium reservation signal transmitted by a guard terminal, according to a QoS provided to the wireless terminal apparatus connected to the access point.

Further, according to another aspect of the present invention, provided is an access point that transmits a signal for shortening a reserved period of the medium which is based on a medium reservation signal, according to period in which communication was performed by any of the wireless terminal apparatuses without using a reserved period which is based on a medium reservation signal.

Further, according to another aspect of the present invention, provided is a guard terminal apparatus that is used with an access point for communicating with a wireless terminal apparatus, and transmits a medium reservation signal in a frequency channel adjacent to a frequency channel used by the access point.

Further, according to another aspect of the present invention, provided is a guard terminal apparatus, wherein at least one frequency channel adjacent to a frequency channel used by the access point comprises a plurality of frequency channels, and includes a frequency channel bundled, for use, with the frequency channel used by the access point.

Further, according to another aspect of the present invention, provided is a guard terminal apparatus, wherein a frequency channel adjacent to a frequency channel used by the access point is a frequency channel that receives an interruption from an adjacent channel.

A program running on an apparatus according to the present invention may be the program that controls a Central Processing Unit (CPU) and the like to cause a computer to operate in such a manner as to realize the functions of the above-described embodiment according to the present invention. Programs or the information handled by the programs are temporarily stored in a volatile memory, such as a Random Access Memory (RAM), a non-volatile memory such as a flash memory, or a Hard Disk Drive (HDD), and other storage systems.

Note that a program for realizing the functions of the embodiments according to the present invention may be recorded in a computer readable recording medium. The program recorded on the recording medium may be loaded to a computer system and executed to realize the functions. It is assumed that the “computer system” refers to a computer system built into the apparatuses, and the computer system includes an operating system and hardware components such as a peripheral device. Further, the “computer-readable recording medium” may be a semiconductor recording medium, an optical recording medium, a magnetic recording medium, a medium that holds a program dynamically for a short period, or another recording medium that can be read by a computer.

Furthermore, each functional block or various characteristics of the apparatuses used in the above-described embodiment may be implemented or performed on an electric circuit, for example, an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor, or may be a conventional processor, a controller, a micro-controller, or a state machine. The above-mentioned electrical circuits may be constituted of a digital circuit, or may be constituted of an analog circuit. Furthermore, in a case that with advances in semiconductor technology, a circuit integration technology appears that replaces the present integrated circuits, it is also possible to use an integrated circuit based on the technology in one aspect of the present invention.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of the present invention defined by claims, and embodiments that are made by suitably combining technical means disclosed according to the different embodiments are also included in the technical scope of the present invention.

Furthermore, a configuration in which constituent elements, described in the respective embodiments and having mutually the same effects, are substituted for one another is also included in the technical scope of the present invention.

### INDUSTRIAL APPLICABILITY

The present invention can be used for a wireless communication apparatus.

The present international application claims priority based on JP 2016-172694 filed on Sep. 5, 2016, and all the contents of JP 2016-172694 are incorporated in the present international application by reference.

### REFERENCE SIGNS LIST

101 Access point
102a to 102d Guard terminal
103a to 103d Monitoring terminal
104a to 104d LCX
105a to 105d LCX
201 Access point
211, 212 LCX
211a, 212a Feeding point
211b, 212b Cable for connecting feeding point
501 Controller
502 Transceiver
503 Antenna unit
504 Quality measuring unit
1001 Access point
1002a to 1002f Guard terminal
1003a to 1003f Monitoring terminal

1-10. (canceled)

11. A guard terminal apparatus to be used with an access point that wirelessly communicates with a wireless terminal apparatus, wherein
the guard terminal apparatus transmits a signal to shorten a reserved period based on a medium reservation signal transmitted by the access point or another guard terminal apparatus to be used with the access point.

12. The guard terminal apparatus according to claim 11, the guard terminal apparatus comprising:
a controller configured to output a signal for performing a medium reservation; and
a leaky coaxial cable configured to wirelessly transmit the signal for performing the medium reservation.

13. The guard terminal apparatus according to claim 12 wherein the leaky coaxial cable is arranged in a part of a coverage of the access point.

14. A guard terminal apparatus to be used with an access point that wirelessly communicates with a wireless terminal apparatus, wherein
the guard terminal transmits a medium reservation signal in at least one frequency channel adjacent to a frequency channel used by the access point.

15. The guard terminal apparatus to according to claim 14, the guard terminal apparatus comprising:
a controller configured to output a signal for performing a medium reservation; and
a leaky coaxial cable configured to wirelessly transmit the signal for performing the medium reservation.

16. The guard terminal apparatus according to claim 14, wherein
the at least one frequency channel adjacent to the frequency channel used by the access point comprises a plurality of frequency channels and includes a frequency channel to be bundled, for use, with a frequency channel used by the access point.

17. The guard terminal apparatus according to claim 14, wherein
the at least one frequency channel adjacent to the frequency channel used by the access point is a frequency channel that receives an interruption from an adjacent channel.

18. An access point for wirelessly communicating with a wireless terminal apparatus, wherein,
in a case that a guard terminal apparatus capable of communicating is present within a coverage of the access point, the access point transmits a signal to shorten a reserved period based on a medium reservation signal transmitted by the guard terminal apparatus, according to a QoS to be provided to the wireless terminal apparatus.

19. The access point according to claim 18, wherein
the access point transmits the signal to shorten the reserved period based on the medium reservation signal, according to a period in which any one of the wireless terminal apparatuses has performed a communication without using a medium reservation period based on the medium reservation signal.

20. A wireless communication apparatus for wirelessly communicating with an access point, wherein,
in a case that an address included in a medium reservation signal transmitted by a guard terminal apparatus to be used with the access point is a prescribed value, a medium reservation by using the medium reservation signal is not performed.
